(19) United States
(12) Patent Application Publication
(10) Pub. No.: US 2026/0073730 A1
(43) Pub. Date: Mar. 12, 2026

(54) 3D CONSISTENT 2D LANDMARK GENERATION FOR FACIAL IMAGES

(71) Applicants: SONY GROUP CORPORATION, TOKYO (JP); SONY CORPORATION OF AMERICA, NEW YORK, NY (US)

(72) Inventors: CHENG YI LIU, SAN JOSE, CA (US); KOHEI MIYAMOTO, LOS ANGELES, CA (US)

(21) Appl. No.: 18/830,077

(22) Filed: Sep. 10, 2024

(51) Int. Cl. G06V 40/16; G06T 3/18; G06T 5/50; G06T 7/70; G06T 17/00; G06V 10/54; G06V 10/75

(52) U.S. Cl. CPC G06V 40/171; G06T 3/18; G06T 5/50; G06T 7/70; G06T 17/00; G06V 10/54; G06V 10/758; G06T 2207/20221; G06T 2207/30201

(57) ABSTRACT

Provided is an electronic device for 3D consistent 2D landmark generation for facial images. The electronic device acquires image data of a face of a person from an image-capture system and determines a first plurality of two-dimensional (2D) facial landmarks based on the image data. Further, the electronic device obtains a 3D face model of the face based on the acquired image data and determines a plurality of 3D facial landmarks on 3D face model. The electronic device compute 3D attribute information is computed based on statistical information associated with neighboring 3D points of 3D face model around corresponding 3D facial landmark of plurality of 3D facial landmarks. Furthermore, electronic device generate input based on application of encoding operation on computed 3D attribute information and determined plurality of 2D facial landmarks and generate second plurality of 2D facial landmarks based on application of neural network-based landmark detector on generated input.

### CROSS-REFERENCE TO RELATED APPLICATIONS/INCORPORATION BY REFERENCE

None.

### FIELD

Various embodiments of the disclosure relate to image processing systems. More specifically, various embodiments of the disclosure relate to an electronic device and method for 3-Dimensional (3D) consistent 2-Dimensional (2D) landmark generation for facial images.

### BACKGROUND

Advancements in facial image processing have enabled the creation of new facial images from a single two-dimensional (2D) image by constructing three-dimensional (3D) models of a person's face. This process involves determining 2D facial landmarks on the 2D image. These landmarks include key points on the face, such as corners of the eyes, tip of the nose, and facial contours. 2D landmarks are crucial for various face-related applications, including face recognition, 3D face reconstruction, and face synthesis and the like. However, detecting 2D landmarks on faces with large pose variations, particularly when comparing front and side views within an image, presents significant challenges. The primary issue may stem from the drastic appearance differences between front and side views of a person's face. In front views, all facial landmarks are typically visible and can be detected directly. In contrast, side views may introduce self-occlusion, where parts of the face may not be visible, leading to incomplete information and making it difficult to accurately locate 2D landmarks on the face. This self-occlusion may obscure crucial landmarks, resulting in unreliable feature extraction and potentially inaccurate landmark detection.

Moreover, subtle differences in 2D landmark appearance due to changes in perspective may further complicate the landmark detection process. Existing methods often struggle with these large-pose scenarios, as they are primarily designed for near-frontal face images and may lack the robustness required to handle the variability introduced by side views.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for 3D consistent 2D landmark generation for facial images as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for 3D consistent 2D landmark generation for facial images, in accordance with an embodiment of the disclosure.

FIG. 2 is a diagram that illustrates an exemplary electronic device of FIG. 1, for 3D consistent 2D landmark generation for facial images, in accordance with an embodiment of the disclosure.

FIG. 3A and FIG. 3B are diagrams that illustrates a processing flowchart for generation and display of 3D semantically consistent facial landmarks based on application of a neural network-based landmark detector on acquired input, in accordance with an embodiment of the disclosure.

FIG. 4 is a diagram that illustrates a processing pipeline for training of neural network based landmark detector for 3D consistent 2D landmark generation for facial images, in accordance with an embodiment of the disclosure.

FIG. 5 is a diagram that illustrates a processing pipeline for 2D landmark detection based on interactive image collection for multi-view images, in accordance with an embodiment of the disclosure.

FIG. 6A and FIG. 6B are images that illustrates an exemplary scenario of images with the 2D facial landmarks on a person and 3D consistent 2D landmarks on the face of the person within the image, in accordance with an embodiment of the disclosure.

FIG. 7 is a flowchart that illustrates operations for an exemplary method for 3D consistent 2D landmark generation for facial images, in accordance with an embodiment of the disclosure.

### DETAILED DESCRIPTION

The disclosed implementations may be found in an electronic device and method for 3D consistent 2D landmark generation for facial images. Exemplary aspects of the disclosure may provide an electronic device (for example, a mobile phone, a smartphone, a desktop computer, a laptop computer, a personal computer, and the like) that may generate 2D facial landmarks (such as eyes, contour of face, or nose), based on a neural network-based landmark detector for 3D consistent 2D landmark generation. The electronic device may acquire image data (for example, an image that includes the face of a person) from an image-capture system to determine a first plurality of 2D facial landmarks (for example, eyes of the person, nose, mouth, jawline, etc.). The electronic device may further determine a plurality of 3D facial landmarks (for example, chin curve, cheekbones, lip contours, nose ridge and tip, etc.) on a 3D face model, and compute 3D attribute information (such as visibility attribute, disparity measure, average landmark confidence, and the like) for each 3D facial landmark based on the 3D face model. The 3D attribute information may be computed based on statistical information associated with neighboring 3D points of the 3D face model around the 3D facial landmarks. The electronic device may further generate an input based on an application of an encoding operation on the computed 3D attribute information and the determined first plurality of 2D facial landmarks and generate a second plurality of 2D facial landmarks based on application of the neural network-based landmark detector on the generated input.

Self-occlusion may obscure crucial landmarks, potentially resulting in unreliable feature extraction and inaccurate landmark detection (for example, 2D landmarks or 3D landmarks). Moreover, subtle differences in 2D landmark appearance due to changes in perspective may further complicate the 2D landmark detection process. Existing methods may often struggle with large-pose scenarios, as such methods may be primarily designed for near-frontal face images and may lack the robustness required to handle the variability introduced by side views. To address such issues, the disclosed electronic device may generate 2D facial landmarks based on the neural network-based landmark detector to produce 2D facial landmarks on the image data which are 3D consistent.

The disclosed electronic device may obtain accurate landmarks in an input 2D face image, ensuring that for visible face regions in the image, the 2D landmarks may be estimated to best fit the 2D image with minimized impact from 3D-to-2D projection errors. For invisible or occluded face regions in the input image, the 2D landmarks may be semantically consistent with 3D-to-2D projection, rather than merely fitting to the visible contours.

The disclosed electronic device may perform 3D attribute extraction, which may calculate the 3D geometric or statistical landmark properties with respect to the view of an input 2D image. The electronic device may implement a 2D multi-attribute landmark detector, which may accept the 3D attributes to generate 3D consistent and 2D accurate landmarks for the input 2D image.

The disclosed electronic device and method may address the issue of existing landmark detection methods and landmark datasets, which may be mostly limited to frontal view faces. Annotating datasets containing slant view faces may be challenging due to self-occlusion. Current datasets may either limit the poses of faces or simply shift the landmarks to the nearest visible face contours in the image, which may be inconsistent in 3D face semantics.

The disclosed electronic device and method may offer several advantages. For example, the electronic device may produce accurate 2D landmarks for slanted faces, potentially aiding in the annotation of high-quality datasets without the need for synthesized images. The statistically computed 3D attributes, for example, landmark visibility and confidence, may be robust even in the presence of individual vertex errors in a 3D model. Unlike most existing methods that may depend on specific 3D face modeling parameters (such as 3DMM), the disclosed approach may be versatile and flexible without any strict constraints. The method may achieve effective training with a smaller dataset (10K˜15K images) compared to state-of-the-art 3D+2D methods (which may require over 65K images). This improvement may be achieved by incorporating concise 3D attributes as priors for the 2D detector.

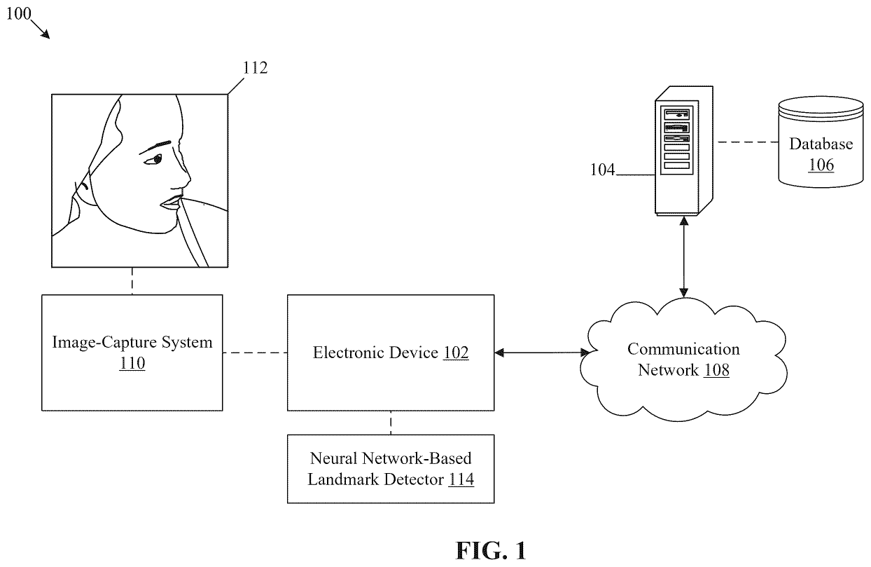

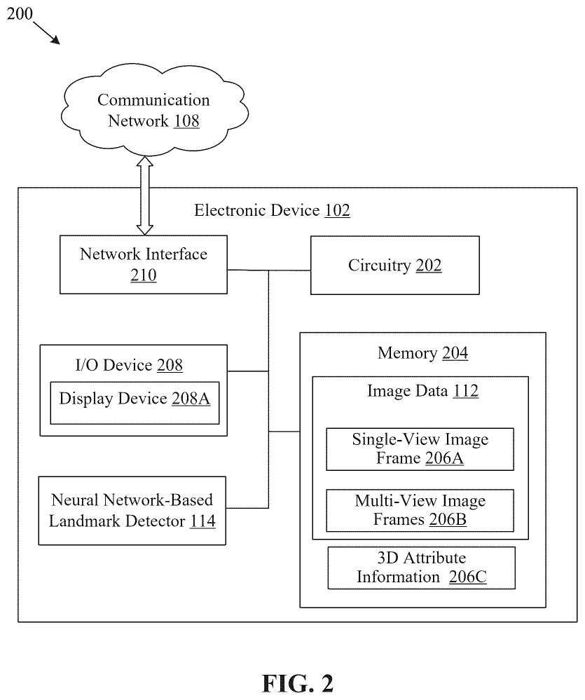

FIG. 1 is a diagram that illustrates an exemplary network environment for 3D consistent 2D landmark generation for facial images, in accordance with an embodiment of the disclosure. With reference to FIG. 1, there is shown a network environment 100. The network environment 100 includes an electronic device 102, a server 104, a database 106, a communication network 108, an image-capture system 110, and a neural network-based landmark detector 114. The electronic device 102 may communicate with the server 104 through the communication network 108. The server 104 may be associated with the database 106. The electronic device 102 and the image-capture system 110 may include a display device 208A (shown in FIG. 2). The database 106 may store acquired image data 112, 3D face models 316B, and 3D attribute information. The display device 208A may be configured to overlay the second plurality of 2D facial landmarks on the image data 112, which may include facial landmarks of a person with a slanted face, occluded face, or the like.

The electronic device 102 may include suitable logic, circuitry, interfaces, and/or code configured to acquire image data 112 of a face from the image-capture system 110. Based on the image data 112, the electronic device 102 may determine a first plurality of 2D facial landmarks and obtain a 3D face model 316B of the face. The electronic device 102 may determine 3D facial landmarks 316A on the 3D face model 316B, which may include one or multiple landmarks on the face. 3D attribute information for the 3D facial landmarks 316A may be computed based on statistical information associated with neighboring 3D points of the 3D face model 316B around corresponding 3D facial landmarks 316A. The electronic device 102 may generate an input by application of an encoding operation on the computed 3D attribute information and the first plurality of 2D facial landmarks. A second plurality of 2D facial landmarks may be generated based on the application of the neural network-based landmark detector 114 on the generated input. The electronic device 102 may overlay the second plurality of 2D facial landmarks on the image data 112 using the display device 208A. Examples of the electronic device 102 may include, but are not limited to, desktop computers, tablets, televisions (TVs), laptops, computing devices, smartphones, cellular phones, mobile phones, recommendation systems, or consumer electronic (CE) devices with displays.

The server 104 in the network environment 100 may include suitable logic, circuitry, interfaces, and/or code configured to receive requests from the electronic device 102 for the image data 112. In some embodiments, the server 104 may store computed 3D attribute information of the 3D facial landmarks 316A. In some embodiments, the server 104 may be configured to determine the first plurality of 2D facial landmarks based on the image data 112 to obtain the 3D attribute information for the 3D facial landmarks 316A. The server 104 may execute operations through web applications, cloud applications, HTTP requests, repository operations, file transfer, and the like. Example implementations of the server 104 may include, but are not limited to, a database server, file server, web server, application server, mainframe server, cloud computing server, or a combination thereof.

In at least one embodiment, the server 104 may be implemented as a plurality of distributed cloud-based resources utilizing various technologies that are well known to those ordinarily skilled in the art. A person with ordinary skill in the art may understand that the scope of the disclosure may not be limited to the implementation of the server 104 and the electronic device 102 as separate entities. In certain embodiments, the functionalities of the server 104 may be incorporated as a single server and/or may be incorporated in its entirety or at least partially in the electronic device 102, without departing from the scope of the disclosure.

The database 106 may be configured to store information associated with the image data 112. The database 106 may store references to the image data 112, which may include faces of different persons with occlusions or slanted views. The database 106 may further store the first 2D facial landmarks or the second plurality of 2D facial landmarks (for example, eye corners, iris centers, eyebrow boundaries, etc.) associated with the image data 112. Additionally, the database 106 may store 3D attribute information of the 3D facial landmarks 316A. The database 106 may be implemented as a relational or non-relational database or may utilize a set of comma-separated values (CSV) files in conventional or big-data storage. The database 106 may be stored or cached on one or more devices or servers, such as the server 104. A device storing the database 106 may be configured to query the database for specific information (such as 2D landmarks of faces in the image data 112) upon receiving a request from the electronic device 102. In response, the device may retrieve and return results (for example, records related to the queried information) based on the received query.

In some embodiments, the database 106 may be hosted on a plurality of servers located at the same or different locations. The operations of the database 106 may be executed using hardware including a processor, a microprocessor (e.g., to perform or control performance of one or more operations), a field-programmable gate array (FPGA), or an application-specific integrated circuit (ASIC). In some instances, the database 106 may be implemented using software.

The communication network 108 may include a communication medium through which the electronic device 102 and the server 104 may communicate with each other. The communication network 108 may be a wired or wireless communication network. Examples of the communication network 108 may include, but are not limited to, the Internet, a cloud network, a Cellular or Wireless Mobile Network (such as Long-Term Evolution (LTE) and 5th Generation (5G) New Radio (NR)), a satellite communication system (using, for example, low Earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, Enhanced Data rates for GSM Evolution (EDGE), IEEE 802.11, Light Fidelity (Li-Fi), IEEE 802.16, IEEE 802.11s, IEEE 802.11g, multi-hop communication, wireless access point (AP) protocols, device-to-device communication protocols, cellular communication protocols, and Bluetooth (BT) communication protocols.

The image-capture system 110 may include suitable logic, circuitry, and interfaces that may be configured to capture one or more images (for example, images including the face of a person). The image-capture system 110 may include various capture modes (for example, multi-view imaging mode and single-view imaging mode). In multi-view imaging mode, the image-capture system 110 may be configured to capture multiple images from different angles or perspectives. In single-view imaging mode, the image-capture system 110 may be configured to capture a single image. Examples of the image-capture system 110 may include, but are not limited to, an image sensor, a wide-angle camera, an action camera, a closed-circuit television (CCTV) camera, a camcorder, a camera with an integrated depth sensor, a cinematic camera, a Digital Single-Lens Reflex (DSLR) camera, a Digital Single-Lens Mirrorless (DSLM) camera, a digital camera, a camera phone, a time-of-flight (ToF) camera, a night-vision camera, and/or other image-capture systems.

The neural network-based landmark detector 114 may refer to a computational model that may utilize artificial neural networks to identify and locate specific facial landmarks in the image data 112. The neural network-based landmark detector 114 may be trained on a dataset of facial images and corresponding landmark annotations to learn patterns and features associated with various facial structures. The neural network-based landmark detector 114 may process input image data, which may include 2D image information to generate a set of 2D facial landmarks (For example, first 2D facial landmarks). These landmarks may represent key facial features such as eyes, nose, mouth, and jawline, among others. The neural network-based landmark detector 114 may be designed to handle various facial poses, expressions, and lighting conditions, and may incorporate techniques to ensure 3D consistency in the generated 2D landmarks. In some implementations, the neural network-based landmark detector 114 may be part of a larger facial analysis system and may interact with other components such as 3D face modeling algorithms or attribute extraction modules. In some embodiments, the neural network-based landmark detector 114 may be implemented on one or more devices, including, but not limited to, a computing device, a smartphone, a cellular phone, a mobile phone, a gaming device, a mainframe machine, a server, a computer workstation, and/or a consumer electronic (CE) device. Examples of the neural network-based landmark detector 114 may include, but are not limited to, a convolutional neural network-based model (such as MobileNet, Multi-task Cascaded Convolutional Network (MTCNN), Openpose, or Facenet), a vision transformer-based model, an embedding-based model, or variants thereof.

The neural network-based landmark detector 114 may be a neural network capable of comparing and generating inferences based on acquired input data (for example, image data 112 of a person's face). The neural network may refer to computational network or a system of artificial neurons which arranged in a plurality of layers. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on a training dataset.

Each node of the neural network may correspond to a mathematical function (e.g., a sigmoid function or a rectified linear unit) with a set of tunable parameters. These parameters may include, for example, weight parameters and regularization parameters. Each node may use the mathematical function to compute an output based on one or more inputs from nodes in other layers (e.g., previous layers) of the neural network. The nodes of the neural network may use the same or different mathematical functions.

During training of the neural network, the parameters of each node may be updated based on whether the output of the final layer for a given input (from the training dataset) matches the correct result, as determined by a loss function. The process may be repeated for the same or different inputs until the loss function reaches a minimum and the training error is minimized. Various training methods may be employed, such as gradient descent, stochastic gradient descent, batch gradient descent, gradient boost, meta-heuristics, and others for the training.

The neural network may include electronic data, for example, as a software component of an application executable on the electronic device 102. The neural network may rely on libraries, external scripts, or other logic/instructions for execution by a processing device, such as a processor or circuitry of the electronic device 102. The neural network may include code and routines configured to enable the electronic device 102 to perform operations for generating 3D-consistent 2D landmarks for facial images. Alternatively, or additionally, the neural network may be implemented using hardware, including a processor, a microprocessor, a field-programmable gate array (FPGA), or an application-specific integrated circuit (ASIC). In some embodiments, the neural network may be implemented using a combination of hardware and software.

In operation, the electronic device 102 may be configured to acquire image data 112 of a person's face from the image-capture system 110. The image data 112 may include a single-view image frame 206A or multi-view image data (for example, the multi-view image data may be acquired from the multi-view image frame 206B) of the face. The image data 112 may include, for example, image frames, videos, moving pictures, or other visual representations.

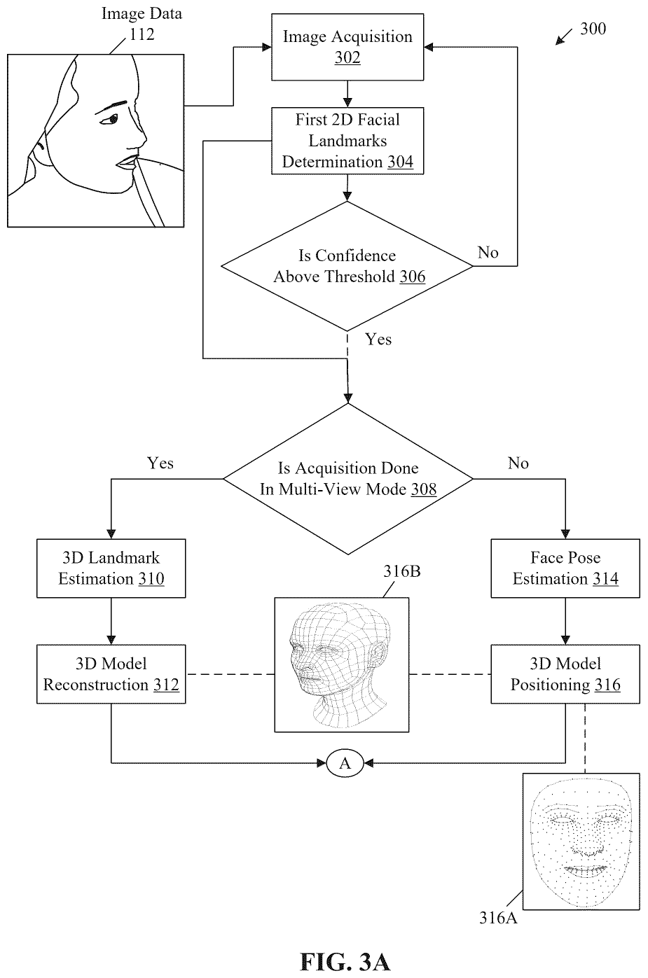

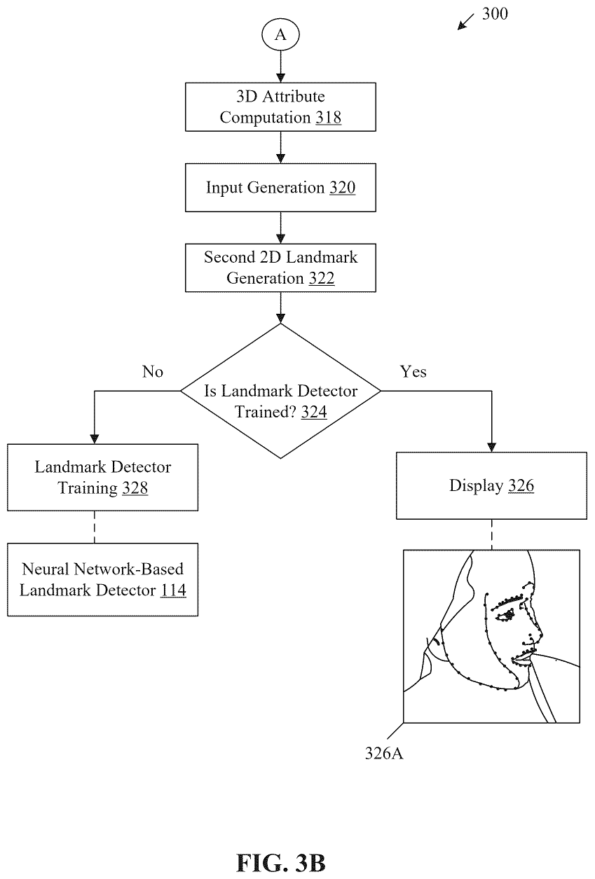

The multi-view image data may be acquired through an interactive multi-view image data capturing process. For instance, the interactive multi-view image data capturing process may utilize a specific capture mode (for example, a multi-view imaging mode) to acquire initial multi-view image data of the face. An image frame may be selected from this initial multi-view image data to determine initial landmark information (For example, first 2D facial landmarks). This initial landmark information may include the initial 2D facial landmarks (or first 2D facial landmarks) and associated confidence information indicating the reliability of the landmark positions on the face. The process of acquiring the image data 112, including the face of the person, is described in further detail in FIG. 3 (at step 302), for example.

The electronic device 102 may be configured to determine the first 2D facial landmarks based on the image data 112. These 2D facial landmarks may include, for example, corners of the eyes, centers of the irises, eyebrow boundaries and arches, and other distinctive facial features. The first 2D facial landmarks may be determined by first detecting the presence and location of the face within the image data. This detection can be performed using various methods, such as deep learning models (for example, Single Shot Multi-Box Detector (SSD)). Once the face is detected, the neural network-based landmark detector 114 may predict the locations of a predefined set of landmarks (which may include both 2D and 3D landmarks).

To accurately predict the 2D landmarks, models are typically trained on large datasets containing images with annotated landmarks. The training process involves minimizing the error between the predicted locations of the landmarks and their known positions in the training data. The neural network-based landmark detector 114 may include a model that extracts features from the image that are relevant to the locations of the landmarks. These features may include edges, textures, or other facial characteristics. The extracted features may then be used in regression or classification methods to estimate the coordinates of each landmark on the image plane.

Some methods may include post-processing steps to refine the landmark positions, such as using local image features or applying smoothing techniques to ensure the landmarks are consistent with the overall facial structure. The determination of the first 2D facial landmarks is described in further detail in FIG. 3 (at step 304).

The electronic device 102 may be configured to obtain the 3D face model 316B based on the acquired image data. The generation of the 3D face model 316B may enable accurate 3D face reconstruction from either a single-view image frame 206A or multi-view image frame 206B. When the image data 112 is determined to be a single-view image frame 206A, the electronic device 102 may acquire a 3D face template with predefined landmarks. The pose information of the person within the single-view image frame 206A may be determined based on data from the image-capture system 110. The 3D face template may then be warped according to this pose information to obtain the 3D face model 316B. The process of determining the 3D facial landmarks 316A on the 3D face model 316B is described in further detail in FIG. 3 (at step 316).

The electronic device 102 may be configured to compute the 3D attribute information for the 3D facial landmarks 316A based on the 3D face model 316B. The 3D attribute information may be computed based on statistical information associated with neighboring 3D points of the 3D face model 316B around corresponding 3D facial landmarks 316A. The 3D attribute information may include, but is not limited to, average landmark confidence associated with the first 2D facial landmarks, landmark surface normal for each 3D facial landmark of the plurality of 3D facial landmarks 316A, disparity measure between a multi-view fused texture around the 3D facial landmarks 316A and texture information around a corresponding each 2D facial landmark of the first plurality of 2D facial landmarks, and visibility attribute information. The visibility attribute may measure visibility of each 2D facial landmark of the first plurality of 2D facial landmarks in the image data 112 with respect to specific camera parameters associated with the image-capture system 110. The visibility attribute may be a continuous variable that corresponds to an extent of the visibility of the each 2D facial landmarks of the first plurality of 2D facial landmarks in the image data 112. The computation of the 3D attribute information for the 3D facial landmarks 316A is described further, for example, in FIG. 3 (at 318).

The electronic device 102 may be configured to generate the input based on the application of an encoding operation on the computed 3D attribute information and the determined first plurality of 2D facial landmarks. The encoding operation may include positional encoding. The positional encoding may be a technique that divides the image data 112 (For example, single-view image frame) into patches, which are then flattened into a sequence of vectors. For each patch, a positional encoding may be generated. The positional encoding may be added to the patch embeddings, allowing the model to determine the location of each patch in the image data 112. The combined embeddings may then be processed by a transformer model, which may consider the spatial relationships between different parts of the image data 112. An example of a positional encoding for image data 112 may be the use of learnable Fourier features or coordinate-based spatial position encoding. The generation of the input based on the application of the encoding operation is described further, for example, in FIG. 3 (at 320).

The electronic device 102 may be configured to generate a second plurality of 2D facial landmarks based on the application of the neural network-based landmark detector 114 on the generated input. The second plurality of 2D facial landmarks may represent 3D-consistent 2D landmark generation for facial images. The 2D-3D facial landmark consistency may be determined by integrating pixel locations of the facial landmarks (for example, the 2D landmarks) and the 3D attribute information. The generation of the second plurality of 2D facial landmarks based on the application of the neural network-based landmark detector 114 is described further, for example, in FIG. 3 (at step 322).

FIG. 2 is a diagram that illustrates an exemplary electronic device 102 of FIG. 1, for 3D consistent 2D landmark generation for facial images, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, an input/output (I/O) device 208, and a network interface 210. In at least one embodiment, the memory 204 may store the image data 112. The image data 112 may include a single-view image frame 206A and/or a multi-view image frames 206B. In at least one embodiment, the I/O device 208 may also include a display device 208A. The circuitry 202 may be communicatively coupled to the memory 204, the I/O device 208, and the network interface 210 through wired or wireless communication within the electronic device 102.

The circuitry 202 may include suitable logic, circuitry, and interfaces that may be configured to execute program instructions associated with different operations to be executed by the electronic device 102. The operations may include the acquisition of image data 112. The image data 112 may include, for example, the face of a person captured by the image-capture system 110. The operations may further include the determination of first of 2D facial landmarks (For example, the first plurality of 2D facial landmarks) based on the acquired image data 112, obtaining a 3D face model 316B, and determining 3D facial landmarks 316A on the 3D face model 316B. The operations may include computation of 3D attribute information 206C for the 3D facial landmarks 316A based on the 3D face model 316B. Further, the operations may include generation of input based on the application of an encoding operation on the computed 3D attribute information 206C and the determined first 2D facial landmarks. The operations may generate second 2D facial landmarks (For example, second plurality of 2D facial landmarks) based on the application of the neural network-based landmark detector 114 on the generated input. The circuitry 202 may include one or more specialized processing units, which may be implemented as an integrated processor or a cluster of processors that collectively perform the functions of the one or more specialized processing units. The circuitry 202 may be implemented based on various processor technologies known in the art. Examples of implementations of the circuitry 202 may include, but are not limited to, an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, interfaces, and/or code that may be configured to store program instructions to be executed by the circuitry 202. The program instructions stored in the memory 204 may enable the circuitry 202 to execute operations of the circuitry 202 (and/or the electronic device 102). In at least one embodiment, the memory 204 may store the image data 112 and 3D attribute information 206C. The image data 112 may include, for example, single-view image frame 206A and multi-view image frames 206B. The 3D attribute information 206C may include average landmark confidence, landmark surface normal, disparity measure, and the like. The memory 204 may further store inputs such as the first 2D facial landmarks and the second 2D facial landmarks (not shown in FIG. 2). Examples of implementations of the memory 204 may include, but are not limited to, Random Access Memory (RAM), Read Only Memory (ROM), Electrically Erasable Programmable Read-Only Memory (EEPROM), Hard Disk Drive (HDD), Solid-State Drive (SSD), CPU cache, and/or Secure Digital (SD) card.

The I/O device 208 may include suitable logic, circuitry, interfaces, and/or code that may be configured to receive an input and provide an output based on the received input. For example, the I/O device 208 may acquire image data 112 from the image-capture system 110. The acquisition of the image data 112 may provide information about the face of a person. Examples of the I/O device 208 may include, but are not limited to, a touch screen, a keyboard, a mouse, a joystick, a microphone, the display device 208A, and a speaker. Examples of the I/O device 208 may further include braille I/O devices, such as braille keyboards and braille readers.

The I/O device 208 may include the display device 208A. The display device 208A may include suitable logic, circuitry, and interfaces that may be configured to receive inputs from the circuitry 202 to render, on a display screen, the second 2D facial landmarks on the image data 112. In at least one embodiment, the display screen may be at least one of a resistive touch screen, a capacitive touch screen, or a thermal touch screen. The display device 208A or the display screen may be realized through several known technologies such as, but not limited to, at least one of a Liquid Crystal Display (LCD), a Light Emitting Diode (LED) display, a plasma display, or an Organic LED (OLED) display technology.

The network interface 210 may include suitable logic, circuitry, and interfaces that may be configured to facilitate communication between the circuitry 202, the server 104, and other devices via the communication network 108. The network interface 210 may be implemented using various known technologies to support wired or wireless communication of the electronic device 102 with the communication network 108. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 210 may be configured to communicate via wireless communication with various networks, such as the Internet, an Intranet, or wireless networks, including cellular telephone networks, wireless local area networks (LANs), short-range networks, and metropolitan area networks (MANs). The wireless communication may utilize one or more of a plurality of communication standards, protocols, and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g, or IEEE 802.11n), voice over Internet Protocol (VOIP), light fidelity (Li-Fi), Worldwide Interoperability for Microwave Access (Wi-MAX), near field communication protocols, and wireless peer-to-peer protocols.

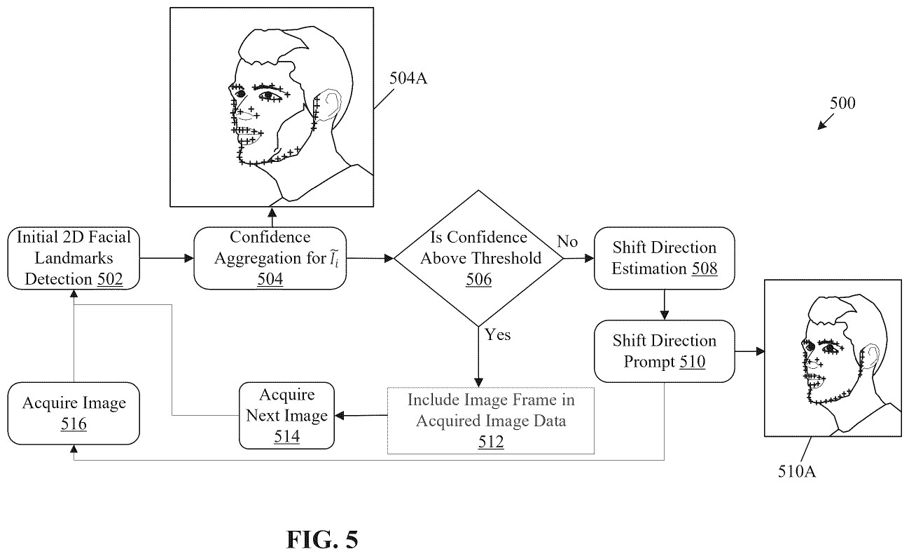

The image data 112 may include facial images of a person with various face angle variations. For example, the image data 112 may include full face angles, tilted head positions, diagonal views of the face, facial asymmetry, and other variations. The single-view image frame 206A may include a single image of the person's face, while the multi-view image frames 206B may include interactive multi-view captured data. The process of capturing the multi-view image frames 206B may be described in detail, for example, in FIG. 5. Furthermore, the functions or operations executed by the electronic device 102, as described in FIG. 1, may be performed by the circuitry 202. The operations executed by the circuitry 202 are described in detail in FIGS. 3A, 3B, 4, 5, 6A, 6B, and 7.

FIG. 3A and FIG. 3B illustrate a processing flowchart for generation and display of 3D semantically consistent facial landmarks based on application of a neural network-based landmark detector 114 on acquired input, in accordance with an embodiment of the disclosure. FIG. 3A and FIG. 3B are explained in conjunction with elements from FIG. 1 and FIG. 2. With reference to FIG. 3A and FIG. 3B, there is shown an exemplary execution flowchart 300 for generation and display of 3D semantically consistent facial landmarks. The execution flowchart 300 may include operations from 302 to 328 executed by a computing device, such as the electronic device 102 of FIG. 1 or the circuitry 202 of FIG. 2.

At 302, image data 112 including the face of a person may be captured by the image-capture system 110. The circuitry 202 may be configured to acquire the image data 112 of the person's face captured by the image-capture system 110. The image-capture system 110 may include, for example, image sensors, scanners, camera phones, and the like. The captured image data 112 may be transmitted to the circuitry 202 of the electronic device 102.

The image-capture system 110 may capture a single-view image frame 206A or multi-view image frames 206B. The multi-view image frames 206B may be captured based on an interactive multi-view capture method. For instance, the image-capture system 110 may capture the multi-view image frames 206B from different angles to acquire facial images of the person for the determination of facial landmarks (for example, 2D landmarks or 3D landmarks).

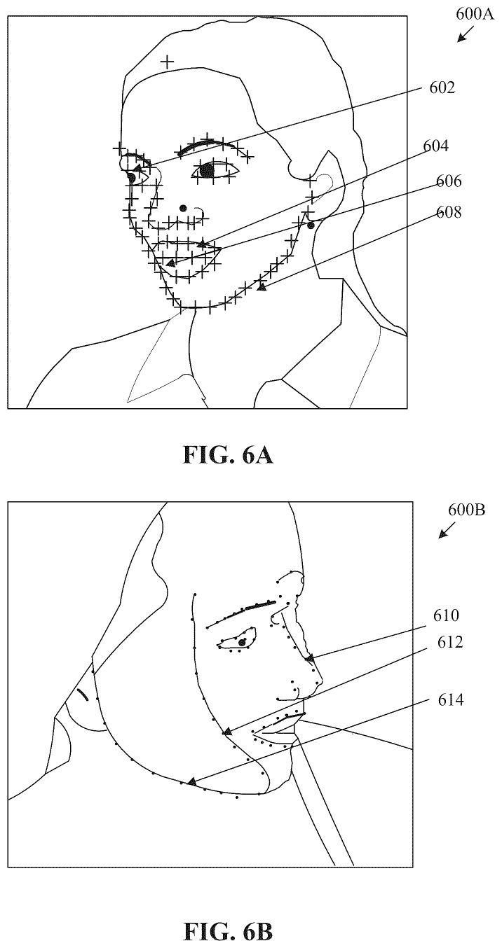

At 304, the first 2D facial landmarks may be determined based on the image data 112. For instance, the circuitry 202 may be configured to determine the first 2D facial landmarks based on the image data 112. The image data 112 may include images of the person's face from various angles, including slanted face angles. The first 2D facial landmarks may be determined detected for the visible facial regions. The 2D landmarks may be estimated to align optimally with the image data 112, without compromising the accuracy of the 3D model estimation. However, for the invisible or occluded face regions in the image data 112, the estimated 2D landmarks may be made semantically consistent with the 3D to 2D facial landmark projection. The 2D landmark coordinates or heatmaps of the image data 112 may be estimated. Further, the 2D landmark coordinates or heatmaps may be triangulated into 3D space. In FIG. 6A, semantically inconsistent 2D facial landmarks in the occluded face components is shown, which may be attributed to the absence of accurate 3D face poses. The first 2D facial landmarks of the input image may be determined based on information such as pixel locations of L landmarks in image Iᵢ and confidence information. Various method for example, Dynamic Sparse Local Patch Transformer (DSLPT), Anisotropic Direction Network (ADNet), and the like, may be used for the determination of the first 2D facial landmarks. The 2D landmark on each input image may be determined using an equation 1, as follows:

$${p}_{i , 1 .. L} , {conf}_{i , 1 .. L} = {f}_{init} ( {I}_{i} ) \qquad ( 1 )$$

where, the p_{i,1 . . . L}, represent the pixel locations of the first 2D facial landmarks in the image data 112. conf_{i,1 . . . L} are confidence scores of the pixel locations of the first 2D facial landmarks, respectively. fᵢₙᵢₜ(Iᵢ) are the first 2D facial landmarks for the image data 112. The fᵢₙᵢₜ(Iᵢ) may be the confidence estimator with the first 2D facial landmarks.

In some embodiments, the first 2D facial landmarks determination may be performed on the multi-view image data. The method for determining first 2D facial landmarks for multi-view image data is further explained in FIG. 5.

At 306, it may be determined whether confidence information associated with positions of the first 2D facial landmarks is above a confidence threshold. The circuitry 202 may be configured to determine whether the confidence information exceeds the confidence threshold. The confidence information may refer to a level of certainty or reliability associated with pixel locations of the detected key points on the face.

In facial landmark detection tasks, each landmark (or key point such as first 2D facial landmarks) may be assigned a confidence score that indicates the accuracy of landmark localization in the image. Higher confidence scores suggest more reliable detections, while lower scores indicate potential inaccuracies or uncertainty. For example, in facial landmarks detection systems, each detected facial feature (e.g., eyes, nose, mouth corners) may be associated with a confidence value. These key points may represent the 2D locations of facial features in the image data 112. The confidence score reflects the model's certainty in the accuracy of each detected facial landmark.

The confidence scores may be used to filter or refine the detected landmarks. Landmarks with confidence scores below a certain threshold may be discarded or subjected to further processing. This approach may help ensure that only the most reliable facial landmarks are used in subsequent stages of the 3D consistent 2D landmark generation process.

In some implementations, the confidence threshold may be dynamically adjusted based on factors such as image quality, lighting conditions, or the specific requirements of the application. This adaptive thresholding may help optimize the trade-off between landmark detection accuracy and the number of detected landmarks. The confidence score may be determined based on the Equation (1).

In scenarios where multi-view image frames 206B may be acquired from the image-capture system 110, movable cameras may capture multiple images to obtain sufficient image data for high-quality multi-view 3D modeling. Given confidence scores for the first 2D facial landmarks, a predefined importance may be assigned to each landmark, and a confidence threshold may be established. When the confidence information of the image data 112 is below the confidence threshold, the control may pass to 302 for the acquisition of multi-view image data from the image-capture system 110. The multi-view image data acquisition process is described in detail in FIG. 5. When the confidence information of the image data 112 exceeds the confidence threshold, the process proceeds to 308.

At 308, acquisition of either the single-view image frame 206A or multi-view image frames 206B may be performed. The circuitry 202 may be configured to acquire image data 112 of the face based on the capture mode (for example, single-view capture mode or interactive multi-view image capturing mode). The multi-view image frames 206B may be acquired using an interactive multi-view image capturing mode. This acquisition process may include detecting the multi-view imaging mode of the image-capture system 110. Image frames may be selected from the initial multi-view image data to determine initial facial landmark information. This initial facial landmark information may include the first 2D facial landmarks and associated confidence information for their positions on the face. An aggregate confidence may be computed based on this confidence information, encompassing confidence scores for each first 2D facial landmark on the face in the image data 112.

If the image data acquisition is performed in multi-view mode, the process advances to 310. If the acquired image data 112 is a single-view image frame 206A, the process moves to 314. At 310, the 3D facial landmarks 316A may be determined for the multi-view image frames 206B. The circuitry 202 may be configured to determine the 3D facial landmarks 316A based on the first 2D facial landmarks for the face in the multi-view image frames 206B and the confidence information associated with positions of the first 2D facial landmarks. The 3D positions of the 3D facial landmarks 316A may be estimated using a triangulation method. Confidence scores (conf_{i,1 . . . L}) may be used as weights for the facial landmarks from different images to mitigate the impact of outliers. The pixel locations of the landmarks in the image data 112 may correspond to the 3D positions derived from the multi-view image frames 206B. The 3D facial landmarks may be represented in equation 2 and explained further in 314:

$${P}_{1 .. L}^{′} = \hat{W} ( R ( {P}_{T , 1 .. L} ) + T ) \qquad ( 2 )$$

At 312, 3D model reconstruction may be performed. The circuitry 202 may be configured to obtain the 3D face model 316B based on application of a 3D reconstruction operation on the multi-view image frames 206B. This 3D reconstruction operation may be based on the confidence information and the 3D facial landmarks 316A. Existing methods such as Photogrammetry, Metashape, COLMAP, or similar techniques may be used in the 3D model reconstruction operations. Therefore, the details of the 3D model reconstruction are omitted from the disclosure for the sake of brevity. The pixel locations of the facial landmarks in the image data 112 may serve as anchor points in the reconstruction process. The confidence information (or the aggregated confidence information) may be used as weights for different images in the reconstruction of the 3D face model 316B.

At 314, the 3D facial landmarks 316A may be determined for the single-view image frame 206A. The circuitry 202 may be configured to determine the 3D facial landmarks 316A on the 3D face model 316B, obtained based on the acquired image data 112. The 3D facial landmarks 316A may be estimated along with the 3D face model 316B and may be obtained from the single-view image frame 206A. To determine the 3D facial landmarks 316A, a 3D face pose may be estimated for the determination of the 3D facial landmarks 316A. Once the 3D face pose estimation is performed, the circuitry 202 may acquire a 3D face template with a plurality of landmarks on the 3D face template based on the determination that the image data 112 is the single-view image frame 206A.

In an embodiment, the circuitry 202 may determine pose information associated with the face in the image data 112 with respect to the image-capture system 110. The pose information may define a relative pose (Pose_{\hat{M},I}) of the face of the person with respect to the image-capture system 110. The relative pose of the face may include rotation (R) and translation (T). The rotation R is an output of the face pose estimation and is represented as a 3×3 rotation matrix that transforms points from the 3D face coordinate system to a coordinate system of the image-capture system 110. The rotation matrix may capture the face's tilt, yaw, and roll. The translation ‘T’ may be estimated assuming that the common camera field of view and the common size of human head. The translation vector T may specify the face movement along with the image-capture system's x, y, and z axes. The common assumption is that the image-capture system's field of view and the size of a human head are known (or can be estimated). The face pose estimation may combine both rotation and translation to determine the 3D orientation and position of the face relative to the image-capture system 110. The rotation matrix R may capture the face's orientation, while the translation vector T accounts for its position. Together, R and T may provide a comprehensive 3D pose estimate, enabling accurate placement of the 3D facial landmarks 316A in 3D space. The 3D face template may be warped to fit the acquired single-view image frame 206A based on equations 2 and 3, which are given as follows:

$$\hat{M} , \hat{W} = Warp ( {M}_{T} , {I}_{s} , R , T ) \qquad ( 3 )$$

$${P}_{1 .. L}^{′} = \hat{W} ( R ( {P}_{T , 1 .. L} ) + T ) \qquad ( 2 )$$

where \hat{M}, is the warped shape and W is the warp filed.
where, M_{T} is a target model (for example, 3D face template), Iₛ is the source image (for example, image data 112). The Warp function applies pose information (R, T) to generate warped shape \hat{M} and warp field Ŵ. By applying the Warp function, the 3D face template may be aligned with the image data 112. This alignment may help accurately estimating attributes such as shape, size and orientation.

$${P}_{1 .. L}^{′}$$

represents the 3D landmark positions from the multi-view image frames 206B.

At 316, 3D model positioning may be performed. The circuitry 202 may be configured to perform the 3D model positioning for the single-view image frame 206A. The single-view image frame 206A may be used with the 3D face template to determine the 3D facial landmarks 316A. Specifically, the 3D face template may be warped using the single-view image frame 206A and the pose information (R, T) to obtain the 3D face model 316B, as shown in equation (2) and (3). The 3D facial landmarks 316A on the 3D face model 316B may be determined based on the warped 3D face template. Specifically, the 3D facial landmarks 316A may be determined to be the plurality of landmarks on the warped 3D face template.

At 318, 3D attribute information 206C may be computed. The circuitry 202 may be configured to compute the 3D attribute information 206C for the 3D facial landmarks 316A based on the 3D face model 316B. The 3D attribute information 206C may include various characteristics associated with each 3D facial landmark, such as surface normal, local curvature, or depth values. This information may be used to enhance the accuracy and consistency of the second 2D facial landmarks detection process. For instance, the 3D statistical attributes of each facial landmark may be defined by the following equation (4):

$${A}_{a , i , 1 .. L} = {f}_{a} ( \hat{M} , {I}_{i} , {C}_{i} ) \qquad ( 4 )$$

where A_{a,i,1 . . . L} is attribute ‘a’ of ‘L’ number of 3D facial landmarks 316A with respect to images

$${}^{′} {I}_{i}^{′}$$

(camera i), given in the 3D face model 316B (\hat{M}).

The method of estimation of the 3D attributes ‘fₛ(\hat{M}, Iᵢ, Cᵢ)’ include two parts. The estimation of the 3D attributes may include obtaining the 3D face model 316B in the correct pose in the world coordinate, followed by extraction of the attributes A_{a,i, 1 . . . L}. The method of obtaining of the 3D face model 316B may be different for the single-view image frame 206A and the multi-view image frames 206B, which is described from 310 to 316 of the FIG. 3A. The 3D attribute information 206C may be computed based on statistical information associated with neighboring 3D points of the 3D face model 316B around the 3D facial landmarks 316A. By way of example, and not limitation, the 3D attribute information 206C may include an average landmark confidence associated with the first 2D facial landmarks. The average landmark confidence may be determined using the Equation (5), as follows:

$${conf}_{l} = \frac{{\sum }_{i = 1}^{N} {conf}_{i , l}}{N} \qquad ( 5 )$$

where confᵢ represents the average landmark confidence, conf_{i,j} represents the confidence scores for the multi-view image frames 206B, and N represents a count of the multi-view image frames 206B.

The 3D attribute information 206C may include the landmark surface normal for each 3D facial landmark of the plurality of 3D facial landmarks 316A. The landmark surface normal ( [symbol] ) may be calculated surrounding the neighborhood of landmark ‘I’. The landmark surface normal may include information such as orientation of the person's face within the image data 112.

The 3D attribute information 206C may include a disparity measure between the multi-view fused texture around each 3D facial landmark of the plurality of 3D facial landmarks 316A and texture information around a corresponding 2D facial landmark of the first 2D facial landmarks in the image data 112. The 3D attribute information 206C may also include determining a visibility attribute that measures the visibility of each 2D facial landmark of the first 2D facial landmarks in the image data 112. The visibility attribute may be a binary variable (referred to as hard visibility) that corresponds to a visibility or an invisibility of each 2D facial landmark in the image data 112. The hard visibility (Aₕ_{ᵥᵢₛ}_{,i,1}) may be determined using the equation (6). Alternatively, the visibility attribute may be a continuous variable that corresponds to an extent of visibility (referred to as soft visibility) of each 2D facial landmark of the first plurality of 2D facial landmarks in the image data 112. The soft visibility

$$( {A}_{{s}_{- vis} , i , l} )$$

may be determined using the Equation (7), as follows:

$${A}_{{h}_{vis} , i , l} = \{ \begin{matrix}0 , & landmark l is invisible in {I}_{i} due to self - \\ & occlusion according to {C}_{i} and \hat{M} \\ 1 , & otherwise\end{matrix} \qquad ( 6 )$$

$${A}_{{s}_{- vis} , i , l} = {A}_{{h}_{vis} , i , l} \times ( {\vec{V}}_{l} \cdot \vec{{o}_{i , l}} ) \qquad ( 7 )$$

where, ( [symbol] ) represents 3D landmark (I) surface normal of on the 3D face model (\hat{M}), which may be calculated surrounding the neighborhood of landmark ‘I’ for robustness. \vec{o_{1,I}} represents a 3D ray from the center of image-capture system 110 to the 3D facial landmarks I for the given Cⱼ and the posed \hat{M}.

At 320, input may be generated based on the application of an encoding operation. The circuitry 202 may be configured to generate the input based on the application of the encoding operation on the computed 3D attribute information 206C and the determined first 2D facial landmarks. As an example, the encoding operation may be a positional encoding operation. The encoding operation may be applied on the 3D attribute information 206C. For the input generation, the image data 112 may be trained to generate the first 2D facial landmark positions (P_{i,1 . . . L}) and the 3D attribute information 206C ‘A_{a,i,1 . . . L}’. The 3D attribute information 206C may further be used in both second 2D facial landmarks detection and loss computation.

At 322, a second 2D facial landmarks may be generated. The circuitry 202 may be configured to generate the second 2D facial landmarks based on the application of the neural network-based landmark detector 114 on the generated input. The second 2D facial landmarks may be displayed on the display device 208A.

At 324, it may be determined whether to train the neural network-based landmark detector 114. If training is required, control may pass to 328; otherwise, control may pass to 326.

At 328, the neural network-based landmark detector 114 may be trained. The circuitry 202 may be configured to train the neural network-based landmark detector 114. An exemplary embodiment of the neural network-based landmark detector 114 may be implemented as a 2D Multi-Attribute Landmark Detector (2D-MALD). The training process may involve two steps to generate initial pixel locations of facial landmarks within the image data 112 and compute the 3D attribute information 206C.

In at least one embodiment, the circuitry 202 may be configured to train the neural network-based landmark detector 114 based on the second 2D facial landmarks. Values of a loss function for the neural network-based landmark detector 114 may be computed based on the second 2D facial landmarks and the 3D attribute information 206C, and the neural network-based landmark detector 114 may be further trained based on the computed values. The second 2D facial landmarks may be 3D-consistent 2D landmark values.

For instance, equation (7) represents the second 2D facial landmarks (or final landmarks) for the image data 112, as follows:

$${p}_{{p}_{i , 1 .. L}}^{final} = {f}_{2 D - MALD} ( {I}_{i} , {p}_{i , 1 .. L} , {A}_{a , i , 1 .. L} ) \qquad ( 7 )$$

$$where {p}_{{p}_{i , 1 .. L}}^{final}$$

are the final estimated landmarks within the image data 112 ′Iⱼ. The final estimated landmarks may be referred as the second 2D facial landmarks. The equation (7) is described in detail in further steps.

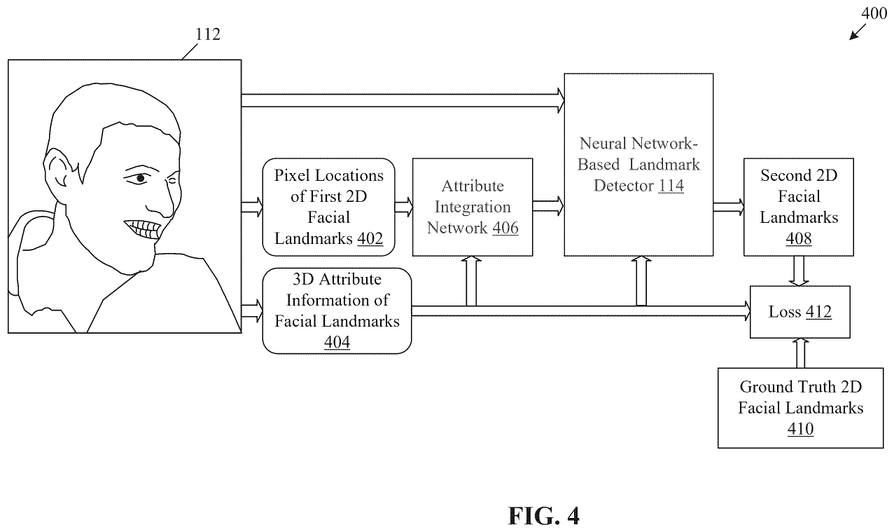

The generated input (for example at 320) may be considered for the training. During training, the initial 2D pixel locations and the 3D attribute information 206C may be integrated to represent the 2D-3D landmark consistency in the image data 112. The 3D attribute information 206C may be utilized in both the neural network-based landmark detector 114 and the loss computation to adapt to individual landmark statistics. A loss function value may be computed based on the second 2D facial landmarks and the 3D attribute information 206C, and the neural network-based landmark detector 114 may be further trained based on this computed value. The training process of the 2D Multi-Attribute Landmark Detector (2D-MALD) is further described in detail in FIG. 4.

At 326, the second 2D facial landmarks may be displayed. The circuitry 202 may be configured to control the display device 208A to overlay the second 2D facial landmarks on the image data 112.

FIG. 4 is a diagram that illustrates a processing pipeline for training the neural network-based landmark detector 114 for 3D consistent 2D landmark generation for facial images, in accordance with an embodiment of the disclosure. FIG. 4 is explained in conjunction with elements from FIG. 1, FIG. 2, FIG. 3A, and FIG. 3B. With reference to FIG. 4, an exemplary execution pipeline 400 is shown for training the neural network-based landmark detector 114 for the 3D consistent 2D landmark generation for image data 112. The execution pipeline 400 may include operations from 402 to 410, which may be executed by a computing device, such as the electronic device 102 of FIG. 1 or the circuitry 202 of FIG. 2.

At 402, the pixel locations of the first 2D facial landmarks may be determined. The image data 112 may be provided as input for the determination of the pixel locations of the first 2D facial landmarks. The first 2D facial landmarks detection in the image data 112 may include, but is not limited to, determination of the pixel locations using a machine learning model that recognizes patterns and features within the image data 112. The machine learning model may include extraction of features from the image data 112 that are relevant for identification of the first 2D facial landmarks, which may include edges, corners, and other distinctive patterns. The machine learning model may be trained on the image data 112 where the landmarks may be manually annotated. This model may learn to associate the extracted features with the landmark positions on the image data. Once trained, the machine learning model may predict the pixel locations of the first 2D facial landmarks (for example, the first plurality of 2D facial landmarks) in new unseen images by recognizing the learned features and inferring their positions. In some embodiments, additional steps may be taken to refine the predicted locations, such as using multi-resolution pixel features to improve accuracy.

At 404, the 3D attribute information 206C of the 3D facial landmarks 316A may be determined. The 3D attribute information 206C may include, but are not limited to, the average landmark confidence associated with the first 2D facial landmarks, landmark surface normal for the 3D facial landmarks 316A, and disparity measure between the multi-view fused texture around the 3D facial landmarks 316A and texture information around the corresponding to the first 2D facial landmarks. Furthermore, the 3D attribute information 206C may include a visibility attribute that measures the visibility of each 2D facial landmark of the first plurality of 2D facial landmarks in the image data 112 with respect to specific parameters associated with the image-capture system 110. The visibility may be represented as a binary variable that corresponds to the visibility or invisibility of each 2D facial landmark of the first plurality of 2D facial landmarks in the image data 112. The binary variable may be referred to as hard visibility. The hard visibility may be defined using as represented in equation (6). Similarly, the visibility attributes may include a continuous variable that corresponds to the extent of visibility of each 2D facial landmark of the first plurality of 2D facial landmarks in the image data 112. The continuous variable may be referred to as soft visibility, which may be defined in Equation (7).

Advantages of using visibility (for example, hard visibility or soft visibility) as the 3D attribute information 206C in the positional encoding may include representation of the face pose in the image data 112, which may be more informative than the whole head pose (with six degrees of freedom). One-to-one correspondence to each landmark may impose clear, individual landmark constraints.

At 406, the 3D attribute information 206C may be integrated with the pixel locations of the image data 112. The integration of the 3D attribute information 2060 may be performed using an attribute integration network. The input data may be fed to the neural network (for example, the attribute integration network 406). The input data may include the pixel locations (P_{i,1 . . . L}) of the image data and the 3D attribute information 206C ‘A_{a,i,1 . . . L}’. In some embodiments, the image data 112 may be the pixel values of images. The attribute integration network 406 may integrate the 3D attribute information 206C to obtain 2D-3D landmark consistency in the generated input.

The attribute integration network 406 may be a neural network capable of comparing and generating inferences based on acquired input data (for example, the pixel locations, 3D attribute information 206C). The neural network may refer to computational network or a system of artificial neurons which arranged in a plurality of layers. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on a training dataset.

Each node of the neural network may correspond to a mathematical function (e.g., a sigmoid function or a rectified linear unit) with a set of tunable parameters. These parameters may include, for example, the pixel locations, 3D attribute information 206C. Each node may use the mathematical function to compute an output based on one or more inputs from nodes in other layers (e.g., previous layers) of the neural network. The nodes of the neural network may use the same or different mathematical functions.

During training of the neural network, the parameters of each node may be updated based on whether the output of the final layer for a given input (from the training dataset) matches the correct result, as determined by a loss function. The process may be repeated for the same or different inputs until the loss function reaches a minimum and the training error is minimized. Various training methods may be employed, such as gradient descent, stochastic gradient descent, batch gradient descent, gradient boost, meta-heuristics, and others for the training.

The neural network may include electronic data, for example, as a software component of an application executable on the electronic device 102. The neural network may rely on libraries, external scripts, or other logic/instructions for execution by a processing device, such as a processor or circuitry 202 of the electronic device 102. The neural network may include code and routines configured to enable the electronic device 102 to perform operations for integrating the 3D attribute information 206C. Alternatively, or additionally, the neural network may be implemented using hardware, including a processor, a microprocessor, a field-programmable gate array (FPGA), or an application-specific integrated circuit (ASIC). In some embodiments, the neural network may be implemented using a combination of hardware and software.

After the input data has propagated through the network, the output may be compared to an expected result using a loss function. This function may calculate the difference between the network's prediction and the actual target values. Common loss functions may include mean squared error for regression tasks and cross-entropy for classification tasks. The loss may then be propagated back through the network, which may allow the attribute integration network 406 to adjust the weights and biases. The steps of forward propagation, loss calculation, and backpropagation may be repeated multiple times over the training dataset. With each iteration, the neural network may learn and improve its predictions by adjusting the weights and biases.

At 408, an exemplary embodiment of training of the neural network-based landmark detector 114 is provided. The neural network-based landmark detector 114 may be the 2D Multi-Attribute Landmark Detector (2D-MALD). Integrated 3D attribute information 206C may be provided as input to the neural network-based landmark detector 114 along with the image data 112. The image data 112 ‘i’ may be considered for training. In training, the initial 2D pixel locations and the 3D attribute information 206C may be integrated to represent the 2D-3D landmark consistency in the generated input. The integration may be performed based on the encoding operation. The 3D attribute information 206C may be used in both neural network-based landmark detector 114 and the loss 412 computation to adapt to the individual landmark statistics. Preferred implementation of the loss may be for example, Euclidean or Gaussian Negative Likelihood and may be weighted according to the 3D attribute information 206C ‘A_{a,i,1 . . . L}’. If the pixel locations ‘p_{i,1 . . . L}’ and the 3D attribute information 206C ‘A_{a,i,1 . . . L}’ carries additional information than the image data 112 Iⱼ, the attribute integration network 406 may achieve an accuracy similar to the neural network-based landmark detector 114 using only the image data (for example, RGB image Iᵢ) to 2D accurate the input.

At 408 and 410, second 2D facial landmarks may be determined. The input given to the neural network-based landmark detector 114 may be the output received from the attribute integration network 406. The second input to the neural network-based landmark detector 114 may include the 3D attribute information 206C. In another example, the input may be the pixel values of the image data 112. The image data 112 may be fed into the neural network-based landmark detector 114, and the input may pass through a series of layers (forward propagation). Each layer may consist of nodes or neurons, and each neuron may have a set of weights and a bias. The data may be transformed at each layer based on these weights and biases, and an activation function may be applied to introduce non-linearity. After the data propagated through the neural network-based landmark detector 114, the output may be compared with the predefined result data using a loss function. This function may calculate the difference between the network's prediction and the actual target values. Common loss functions may include mean squared error for regression tasks and cross-entropy for classification tasks. The loss may be then propagated back through the neural network-based landmark detector 114, which may allow the neural network-based landmark detector 114 to adjust the weights and biases. The pixel location P*p_{i,1 . . . L} may indicate the new locations (For example, second plurality of 2D facial landmarks) after loss function. The forward propagation may include, loss calculation, and backpropagation are repeated multiple times over the training dataset. With each iteration, the neural network-based landmark detector 114 may learn and improve its predictions by adjusting the weights and biases. The neural network-based landmark detector 114 may be evaluated with a new data, known as the validation or test set to perform on the new set of images (For example, image data 112) acquired by the image-capture system 110. Once trained, the neural network-based landmark detector 114 may predict the second 2D facial landmarks, on the new set of images (For example, image data 112), by recognizing the learned features and inferring the positions.

FIG. 5 is a diagram that illustrates a processing pipeline for the plurality of second 2D facial landmark detection based on interactive image collection for multi-view image frames 206B, in accordance with an embodiment of the disclosure. FIG. 5 is explained in conjunction with FIG. 1, FIG. 2, FIG. 3A, FIG. 3B and FIG. 4. With reference to FIG. 5, an exemplary interactive image collection method 500 is shown.

At 502, 2D facial landmarks (for example, first plurality of 2D facial landmarks) may be detected. The 2D facial landmarks may be determined based on the existing methods using equation (1).

The method of first 2D facial landmarks detection may use the confidence estimators as fᵢₙᵢₜ( ) to determine the confidence information. The confidence estimators may be, for example used are DSLPT, ADNet, and the like. The aggregate confidence may be determined upon the detection that a capture mode of the image-capture system 110 is the multi-view imaging mode. The initial multi-view image data may be acquired based on the capture mode.

At 504, the confidence information may be aggregated for the image data 112 (Iᵢ). The confidence information may be determined based on the equation (8), as follows:

$${\tilde{conf}}_{i} = \frac{{\sum }_{l = i}^{L} {w}_{l} * {\tilde{conf}}_{i , l}}{{\sum }_{l = i}^{L} {w}_{l}} \qquad ( 8 )$$

where, [symbol] corresponds to the confidence of [symbol] in the x-coordinates and y-coordinates in the image data 112 and 0≤ [symbol] ≤1.0, and [symbol] represents the aggregate confidence for images [symbol] . The aggregate confidence may be a 2D vector.

The direction of the image-capture system 110 may be shifted to capture the image data 112 (For example, multi-view image frames 206B) in different angles. For estimation of the shift direction, following equations (9) and (10) may be used:

$$\vec{{Dir}_{i}} = \frac{{\sum }_{l = i}^{L} {w}_{l} * ( \vec{{p}_{i , l}} - \vec{{c}_{i}} ) * ( 1. - {\tilde{conf}}_{i , l} )}{{\sum }_{l = i}^{L} {w}_{l}} \qquad ( 9 )$$

$$\vec{{Dir}_{i}} = \frac{{\sum }_{l = i}^{L} {w}_{l} * ( \vec{{p}_{i , l}} - \vec{{c}_{i}} ) \cdot ( ( 1. , 1. ) - \vec{{\tilde{conf}}_{i , l}} )}{{\sum }_{l = i}^{L} {w}_{l}} \qquad ( 10 )$$

$$if \vec{{\tilde{conf}}_{ι , l}} is 2 D$$

where [symbol] represents the center of the image data 112. The equation (8) represents the aggregate confidence for image data [symbol] . The aggregate confidence may include predefined importance of each landmark w_{1 . . . L} and the confidence information. The equations (9) and (10) represent the estimation of the direction shift. The direction shift ( [symbol] ) may include the overall predefined importance of each landmark w_{1 . . . L} and pixel location for the remaining views of the multi-view image frames 206B and the confidence information. The equation (11) represents the confidence information of the first 2D facial landmarks.

At 506, when it is determined that the confidence measures are above the threshold, control may pass to 512 and when the confidence measures are below the threshold, direction of the image-capture system 110 may be shifted. The confidence information for pixel locations in the first 2D facial landmarks may refer to the level of certainty or reliability associated with detected key points. In tasks like detection of the initial facial landmarks, each landmark (or key point) may be assigned a confidence score that indicates accuracy of the landmark. Higher confidence scores imply more reliable detections, while lower scores suggest potential inaccuracies or uncertainty.

At 508 and 510, the direction of the image-capture system 110 may be shifted. If the multi-view image frames 206B is captured by the image-capture system 110, then the input of the first 2D facial landmarks detection (at 502) may be revised to obtain the image data (For example, multi-view image frames 206B), which are sufficient for high quality multi-view 3D modeling. The direction of the image-capture system 110 may be shifted and prompted on the display device 208A. Further, the control may be passed to 516 for the additional image (For example, multi-view image frames 206B) acquisition by the image-capture system 110.

At 514, next image may be acquired by the image-capture system 110 and the first 2D facial landmarks may be detected for the next captured image. The process of first 2D facial landmarks detection (at 502) may be repeated based on the acquired next image.

FIG. 6A and FIG. 6B illustrate exemplary scenarios of images with 2D facial landmarks on a person and 3D-consistent 2D landmarks on the face of the person within the image, in accordance with an embodiment of the disclosure. FIG. 6A and FIG. 6B are explained in conjunction with FIG. 1, FIG. 2, FIG. 3A, FIG. 3B, FIG. 4, and FIG. 5. With reference to FIG. 6A and FIG. 6B, an exemplary scenario 600 for the 2D facial landmarks is shown.

FIG. 6A depicts an output image 600A of conventional landmark detector. A dataset of images having the faces of the person viewed at an angle, particularly those with a slant greater than 25 degrees. The datasets of the image data 112 may face difficulties due to self-occlusion, which occurs when parts of the face obstruct other parts from view due to the angle, making consistent annotation challenging (as shown in 602, 606). To mitigate this issue, existing datasets often limit the range of facial poses or inconsistently annotate only the visible parts of the face (for example 604, 608), which does not adequately represent the face in 2D space. Moreover, developing analytical detection methods to recognize these slanted faces is particularly challenging due to the significant difference in facial appearance when viewed from the front compared to the side. This large variation in appearance makes it difficult to create rule-based systems that can accurately detect faces from different angles. The shortage of quality data on slanted faces, resulting from the aforementioned issues with existing datasets, hampers the training the conventional landmark detection methods. Without sufficient and consistent examples of faces viewed at various angles, these learning-based methods may not be effectively trained to recognize such poses.

FIG. 6B illustrates an exemplary output of the proposed neural network-based landmark detector 114 trained as described in in FIG. 4. As shown, there may be a noticeable semantic discrepancy between the 2D facial landmarks of the left and right face contours as shown in 600B. The neural network-based landmark detector 114 may adjust the 2D facial landmarks indicating face contour of the 612 may be aligned with 614. This adjustment aims to ensure that the 2D facial landmarks on both sides of the face contour may correspond symmetrically (for example 612, 614), maintaining consistency with the three-dimensional structure of the face. For the visible face regions (for example 610, 614), the 2D landmarks are estimated to best fit 2D facial image without compromising the accuracy of the 3D face model estimation.

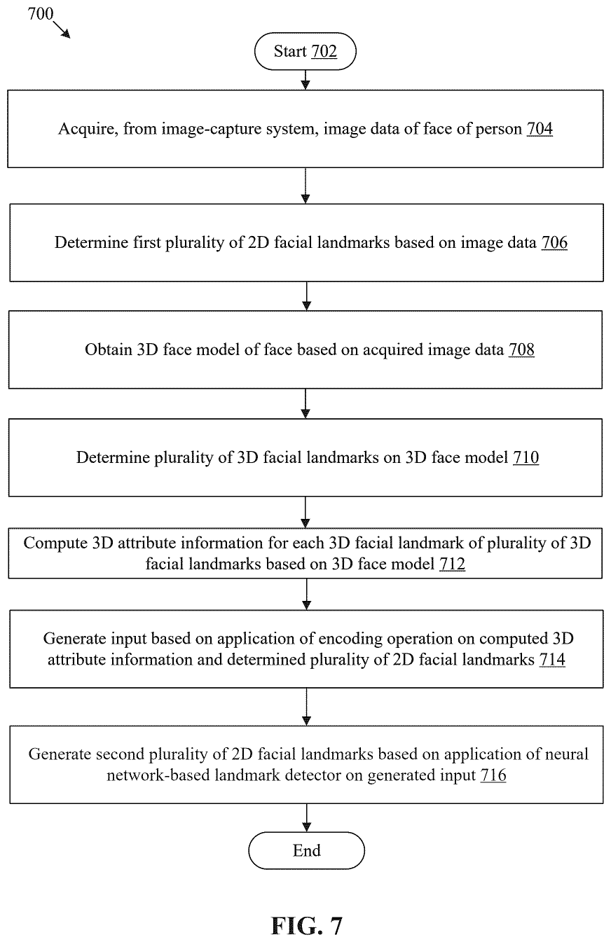

FIG. 7 is a flowchart that illustrates operations for an exemplary method for 3D consistent 2D landmark generation for facial images, in accordance with an embodiment of the disclosure. FIG. 7 is explained in conjunction with elements from FIG. 1, FIG. 2, FIG. 3A, FIG. 3B, FIG. 4, FIG. 5, FIG. 6A, and FIG. 6B. With reference to FIG. 7, there is shown a flowchart 700. The operations from 702 to 716 may be implemented by any computing system, such as, by the electronic device 102 of FIG. 1. The operations may start at 702 and may proceed to 704.

At 704, image data 112 of the face of the person may be acquired from the image-capture system 110. The circuitry 202 may be configured to acquire image data 112 of the face of the person from the image-capture system 110. The image data 112 may include different images with the faces of persons. The images may include surveillance footage, video conference, images captured from the image-capture system 110 and the like. In an embodiment, the image data 112 may be the single-view image frame 206A and/or multi-view image frames 206B of the face. The capture mode may decide whether the image data 112 captured are the single-view image frame 206A or multi-view image frames 206B.

At 706, the first 2D facial landmarks may be determined based on the image data 112. The circuitry 202 may be configured to determine the first 2D facial landmarks (for example, eyes of the person, nose, mouth, jawline, and the like) based on the image data 112. In an example, the first 2D facial landmarks may be determined by detecting presence and location of the face within the image data 112. Once the face is detected within the image data 112, the locations of the predefined set of landmarks within the image data 112 may be predicted. To accurately predict the first 2D facial landmarks, models (For example, 2D landmark detection model) are trained on large datasets containing the image data 112 with annotated landmarks.

At 708, 3D face model 316B of the face of the person may be obtained based on the acquired image data 112. The circuitry 202 may be configured to obtain the 3D face model 316B based on the acquired image data 112. The generation of the 3D face model 316B may enable precise reconstruction of the 3D face from either the single-view image frame 206A or multi-view image frames 206B taken from different views. When the image data 112 identified as the single-view image frame 206A, the 3D face template may be obtained. This 3D face template may have landmarks positioned on it in accordance with the recognition that the image data 112 represents the single-view image frame 206A. The pose information may be determined associated with the face in the image data 112 with respect to the image-capture system 110. The 3D face template may be warped on the pose information to obtain the 3D face model 316B.

At 710, 3D facial landmarks 316A on the 3D face model 316B may be determined. The circuitry 202 may be configured to determine the 3D facial landmarks 316A on the 3D face model 316B. The 3D face model 316B ‘M’ may be generated from the multi-view image frames 206B. The 3D landmark positions may be estimated based on the triangulation method. The examples of the 3D facial landmarks 316A may include corners of the eyes, tip of the nose, corners of the mouth, and the like.

At 712, 3D attribute information 206C for each 3D facial landmarks 316A may be computed based on the 3D face model 316B. The circuitry 202 may be configured to compute 3D attribute information 206C for each 3D facial landmark of the plurality of 3D facial landmarks 316A based on the 3D face model 316B. The 3D attribute information 206C is computed based on statistical information associated with the neighboring 3D points of the 3D face model 316B around the corresponding 3D facial landmarks 316A. The operations may include computation of 3D attribute information 206C for the 3D facial landmarks 316A based on the 3D face model 316B. The circuitry 202 may be configured to generate the input based on the application of the encoding operation on the computed 3D attribute information 206C and the determined 2D facial landmarks. The operations may generate the second 2D facial landmarks based on the application of the neural network-based landmark detector 114 on the generated input.

At 714, the input may be generated based on the application of the encoding operation on the computed 3D attribute information 206C and the determined first 2D facial landmarks. The circuitry 202 may be configured to generate the input based on the application of the encoding operation on the computed 3D attribute information 206C and the determined first 2D facial landmarks. The encoding operation may include the positional encoding. The 3D attribute information 206C may be integrated with the first 2D facial landmarks (2D P_{i,1 . . . L} and A_{a,i,1 . . . L}) to represent the 2D-3D landmark consistency in the image data 112. The neural network-based landmark detector 114 may be the 2D landmark detector and/or 3D landmark detector.

At 716, the second 2D facial landmarks may be generated. The circuitry 202 may be configured to generate the second 2D facial landmarks based on application of the neural network-based landmark detector 114 on the generated input. The generated input is the integration of the 3D attribute information 206C and the first 2D facial landmarks. The display device 208A may be configured to overlay the second 2D facial landmarks on the image data 112.

Although the flowchart 700 is illustrated as discrete operations, such as 704, 706, 708, 710, 712, 714, and 716, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the electronic device 102). The computer-executable instructions may cause the machine and/or computer to perform operations that include 3D consistent 2D landmark generation for facial images. The operations may include acquisition of image data of a face of a person from an image-capture system 110. The operations may further include determination of a first plurality of 2D facial landmarks based on the image data. The operations may further include a 3D face model 316B of the face obtaining based on the acquired image data. The operation may further include computation of 3D attribute information 206C for each 3D facial landmark of the 3D facial landmarks 316A based on the 3D face model 316B. The 3D attribute information 206C is computed based on statistical information associated with neighboring 3D points of the 3D face model 316B around the corresponding 3D facial landmark of the plurality of 3D facial landmarks 316A. The operations may further include generation of an input based on an application of an encoding operation on the computed 3D attribute information 206C and the determined plurality of 2D facial landmarks. The operations may further include generation of a second plurality of 2D facial landmarks based on application of a neural network-based landmark detector 114 on the generated input.

Exemplary aspects of the disclosure may include an electronic device (such as, the electronic device 102 of FIG. 1) that may include circuitry 202 (such as, the circuitry 202), that may be communicatively coupled to the electronic device (such as, the electronic device 102 of FIG. 1). The electronic device 102 may further include memory (such as, the memory 204 of FIG. 2). The circuitry 202 may be configured to acquire, from an image-capture system 110, image data of a face of a person. The circuitry 202 may be configured to determine a first plurality of two-dimensional (2D) facial landmarks based on the image data. The circuitry 202 may be further configured to obtain a three-dimensional (3D) face model of the face based on the acquired image data. The circuitry 202 may be configured to determine a plurality of 3D facial landmarks 316A on the 3D face model 316B. The circuitry 202 may be further configured to compute 3D attribute information 206C for each 3D facial landmark of the plurality of 3D facial landmarks 316A based on the 3D face model 316B. The 3D attribute information 206C is computed based on statistical information associated with neighboring 3D points of the 3D face model 316B around a corresponding 3D facial landmark of the plurality of 3D facial landmarks 316A. Further, the circuitry 202 may be configured to generate an input based on an application of an encoding operation on the computed 3D attribute information 206C and the determined plurality of 2D facial landmarks. Further, the circuitry 202 may be configured to generate a second plurality of 2D facial landmarks based on application of a neural network-based landmark detector 114 on the generated input.

In accordance with an embodiment, the circuitry 202 may be further configured to control a display device 208A to overlay the second plurality of 2D facial landmarks on the image data.

In accordance with an embodiment, the image data is a single-view image frame 206A.

In accordance with an embodiment, the image data is multi-view image data of the face.

In accordance with an embodiment, the circuitry 202 may be further configured to detect a capture mode as a multi-view imaging mode of the image-capture system 110 to acquire, based on the capture mode, initial multi-view image data of the face. Further, the circuitry 202 may be further configured to select an image frame from the initial multi-view image data and determine, based on the selected image frame, initial landmark information comprising a plurality of initial 2D facial landmarks and confidence information associated with positions of the plurality of initial 2D facial landmarks on the face. Further, the circuitry 202 may be further configured to compute an aggregate confidence based on the confidence information.

In accordance with an embodiment, the circuitry 202 is further configured to include the selected image frame in the acquired image data based on the aggregate confidence that is above a confidence threshold.

In accordance with an embodiment, the circuitry 202 may be further configured to determine adjustment information associated with a position of the image-capture system 110 based on the aggregate confidence that is below a confidence threshold and control the image-capture system 110 or a display device 208A associated with the electronic device 102 to display a prompt based on the adjustment information. A replacement image frame is acquired for the selected image frame. The image data is acquired further based on a replacement of the selected image frame with the replacement image frame.

In accordance with an embodiment, the circuitry 202 may be further configured to determine the image data to be a single-view image frame 206A and acquire a 3D face template with a plurality of landmarks on the 3D face template based on the determination that the image data is the single-view image frame 206A. The circuitry 202 may be further configured to determine pose information associated with the face in the image data with respect to the image-capture system 110 and warp the 3D face template based on the pose information to obtain the 3D face model 316B.

In accordance with an embodiment, the circuitry 202 may be further configured to determine the plurality of 3D facial landmarks 316A based on the first plurality of 2D facial landmarks for the face in the multi-view image data and confidence information associated with positions of the first plurality of 2D facial landmarks and obtain the 3D face model 316B based on application of a 3D reconstruction operation on the multi-view image data. The 3D reconstruction is based on the confidence information and the plurality of 3D facial landmarks 316A.

In accordance with an embodiment, the 3D attribute information 206C includes an average landmark confidence associated with the first plurality of 2D facial landmarks.

In accordance with an embodiment, the 3D attribute information 206C includes a landmark surface normal for each 3D facial landmark of the plurality of 3D facial landmarks 316A.

In accordance with an embodiment, the 3D attribute information 206C includes a disparity measure between a multi-view fused texture around a 3D facial landmark of the plurality of 3D facial landmarks 316A and texture information around a corresponding 2D facial landmark of the first plurality of 2D facial landmarks in the image data.

In accordance with an embodiment, the 3D attribute information 206C includes a visibility attribute that measures a visibility of each 2D facial landmark of the first plurality of 2D facial landmarks in the image data with respect to a specific camera parameter associated with the image-capture system 110.

In accordance with an embodiment, the visibility attribute is a binary variable that corresponds to the visibility or an invisibility of each 2D facial landmark of the first plurality of 2D facial landmarks in the image data.

In accordance with an embodiment, the visibility attribute is a continuous variable that corresponds to an extent of the visibility of each 2D facial landmark of the first plurality of 2D facial landmarks in the image data.

In accordance with an embodiment, the encoding operation is a positional encoding operation.

In accordance with an embodiment, the circuitry 202 is further configured to train the neural network-based landmark detector 114 based on the second plurality of 2D facial landmarks.

In accordance with an embodiment, the circuitry 202 is further configured to compute a value of a loss function based on the second plurality of 2D facial landmarks and the 3D attribute information 206C, and the neural network-based landmark detector 114 is trained further based on the computed value.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims. cm What is claimed is:

1. An electronic device, comprising:
circuitry configured to:
acquire, from an image-capture system, image data of a face of a person;
determine a first plurality of two-dimensional (2D) facial landmarks based on the image data;
obtain a three-dimensional (3D) face model of the face based on the acquired image data;
determine a plurality of 3D facial landmarks on the 3D face model;
compute 3D attribute information for each 3D facial landmark of the plurality of 3D facial landmarks based on the 3D face model,
wherein the 3D attribute information is computed based on statistical information associated with neighboring 3D points of the 3D face model around a corresponding 3D facial landmark of the plurality of 3D facial landmarks;
generate an input based on an application of an encoding operation on the computed 3D attribute information and the determined plurality of 2D facial landmarks; and
generate a second plurality of 2D facial landmarks based on application of a neural network-based landmark detector on the generated input.

2. The electronic device according to claim 1, wherein the circuitry is further configured to control a display device to overlay the second plurality of 2D facial landmarks on the image data.

3. The electronic device according to claim 1, wherein the image data is a single-view image frame.

4. The electronic device according to claim 1, wherein the image data is multi-view image data of the face.

5. The electronic device according to claim 1, wherein the circuitry is further configured to:
detect a capture mode as a multi-view imaging mode of the image-capture system;
acquire, based on the capture mode, initial multi-view image data of the face;
select an image frame from the initial multi-view image data;
determine, based on the selected image frame, initial landmark information comprising a plurality of initial 2D facial landmarks and confidence information associated with positions of the plurality of initial 2D facial landmarks on the face; and
compute an aggregate confidence based on the confidence information.

6. The electronic device according to claim 5, wherein the circuitry is further configured to include the selected image frame in the acquired image data based on the aggregate confidence that is above a confidence threshold.

7. The electronic device according to claim 5, wherein the circuitry is further configured to:
determine adjustment information associated with a position of the image-capture system based on the aggregate confidence that is below a confidence threshold;
control the image-capture system or a display device associated with the electronic device to display a prompt based on the adjustment information; and
acquire a replacement image frame for the selected image frame,
wherein the image data is acquired further based on a replacement of the selected image frame with the replacement image frame.

8. The electronic device according to claim 1, wherein the circuitry is further configured to:
determine the image data to be a single-view image frame;
acquire a 3D face template with a plurality of landmarks on the 3D face template based on the determination that the image data is the single-view image frame;
determine pose information associated with the face in the image data with respect to the image-capture system; and
warp the 3D face template based on the pose information to obtain the 3D face model.

9. The electronic device according to claim 1, wherein the image data is multi-view image data of the face, and wherein the circuitry is further configured to:
determine the plurality of 3D facial landmarks based on the plurality of 2D landmarks for the face in the multi-view image data and confidence information associated with positions of the plurality of 2D landmarks; and
obtain the 3D face model based on application of a 3D reconstruction operation on the multi-view image data,
wherein the 3D reconstruction is based on the confidence information and the plurality of 3D facial landmarks.

10. The electronic device according to claim 1, wherein the 3D attribute information includes an average landmark confidence associated with the first plurality of 2D facial landmarks.

11. The electronic device according to claim 1, wherein the 3D attribute information includes a landmark surface normal for each 3D facial landmark of the plurality of 3D facial landmarks.

12. The electronic device according to claim 1, wherein the 3D attribute information includes a disparity measure between a multi-view fused texture around a 3D facial landmark of the plurality of 3D facial landmarks and texture information around a corresponding 2D facial landmark of the first plurality of 2D facial landmarks in the image data.

13. The electronic device according to claim 1, wherein the 3D attribute information includes a visibility attribute that measures a visibility of each 2D facial landmark of the plurality of 2D facial landmarks in the image data with respect to a specific camera parameter associated with the image-capture system.

14. The electronic device according to claim 13, wherein the visibility attribute is a binary variable that corresponds to the visibility or an invisibility of each 2D facial landmark of the plurality of 2D facial landmarks in the image data.

15. The electronic device according to claim 13, wherein the visibility attribute is a continuous variable that corresponds to an extent of the visibility of each 2D facial landmark of the plurality of 2D facial landmarks in the image data.

16. The electronic device according to claim 1, wherein the encoding operation is a positional encoding operation.

17. The electronic device according to claim 1, wherein the circuitry is further configured to:
train the neural network-based landmark detector based on the second plurality of 2D facial landmarks.

18. The electronic device according to claim 17, wherein the circuitry is further configured to compute a value of a loss function based on the second plurality of 2D facial landmarks and the 3D attribute information.

19. A method, comprising:
in an electronic device:
acquiring, from an image-capture system, image data of a face of a person;
determining a first plurality of two-dimensional (2D) facial landmarks based on the image data;
obtaining a three-dimensional (3D) face model of the face based on the acquired image data;
determining a plurality of 3D facial landmarks on the 3D face model;
computing 3D attribute information for each 3D facial landmark of the plurality of 3D facial landmarks based on the 3D face model,
wherein the 3D attribute information is computed based on statistical information associated with neighboring 3D points of the 3D face model around a corresponding 3D facial landmark of the plurality of 3D facial landmarks;
generating an input based on an application of an encoding operation on the computed 3D attribute information and the determined plurality of 2D facial landmarks; and
generating a second plurality of 2D facial landmarks based on application of a neural network-based landmark detector on the generated input.

20. A non-transitory computer-readable medium having stored thereon, computer-executable instructions that when executed by an electronic device, causes the electronic device to execute operations, the operations comprising:
acquiring, from an image-capture system, image data of a face of a person;
determining a first plurality of two-dimensional (2D) facial landmarks based on the image data;
obtaining a three-dimensional (3D) face model of the face based on the acquired image data;
determining a plurality of 3D facial landmarks on the 3D face model;
computing 3D attribute information for each 3D facial landmark of the plurality of 3D facial landmarks based on the 3D face model,
wherein the 3D attribute information is computed based on statistical information associated with neighboring 3D points of the 3D face model around a corresponding 3D facial landmark of the plurality of 3D facial landmarks;
generating an input based on an application of an encoding operation on the computed 3D attribute information and the determined plurality of 2D facial landmarks; and
generating a second plurality of 2D facial landmarks based on application of a neural network-based landmark detector on the generated input.
